(19) United States
(12) Patent Application Publication
(10) Pub. No.: US 2014/0190882 A1
(43) Pub. Date: Jul. 10, 2014

(54) Fluid Cleaning Medium and a Fluid Cleaning Device

(71) Applicant: Anthony John Yellen, Cardiff South Wales (GB)

(72) Inventor: Anthony John Yellen, Cardiff South Wales (GB)

(21) Appl. No.: 14/234,771

(22) PCT Filed: Jul. 26, 2012
(86) PCT No.: PCT/GB2012/051797

§ 371 Date: Jan. 24, 2014

(30) Foreign Application Priority Data
Jul. 27, 2011 (GB) 1112874.1

(51) Int. Cl. C02F 1/00

(52) U.S. Cl. CPC C02F 1/006
USPC 210/335; 210/322

(57) ABSTRACT

A fluid cleaning device is disclosed for cleaning pond water and the like. The device comprises a flow path for conveying a fluid flow between a device inlet and a device outlet, the path comprising a cleaning chamber having an inlet for receiving fluid into the chamber and an outlet for passing fluid from the chamber. The chamber comprises a cleaning medium which is arranged to clean the fluid as it passes along the path between the chamber inlet and the chamber outlet. The medium comprises a plurality of discrete cleaning units which separately comprise a body having a surface comprising a plurality of protuberances disposed thereon, which are arranged to maintain a separation of the body surfaces of adjacent units of the medium to enable fluid to pass between the units. The device further comprises dispersing means disposed within the duct upstream of the cleaning chamber for dispersing the fluid flow across the cleaning medium to encourage the interaction of the water with the cleaning medium.

The present invention relates to a fluid cleaning medium and to a fluid cleaning device.

It is necessary to clean pond water to ensure that the water remains suitable to support pond life and this cleaning is typically achieved using filters and the like. The filters typically serve to mechanically remove any detritus from the water and also as a medium for the colonization of nitrifying bacteria, such as nitrosomonas and nitrobacter, which convert harmful ammonia and nitrites within the water to less harmful nitrates.

During the initial use of the filter however, when the colonization of the bacteria is taking place, toxic levels of ammonia and nitrite are found to develop which can cause tissue damage to the gills and kidneys of fish. High levels of ammonia is also found to suppress the immune system of fish, such as koi, thereby rendering the fish vulnerable to disease and infection. These so-called immature biological filters further result in high levels of nitrite developing in the water which is found to reduce the amount of oxygen that can be absorbed by fish. This can thus lead to hypoxia and eventually the death of fish and other forms of pond life.

The filtration medium used in such filters typically comprises by-products from industrial process, such as sand, which provide an excellent mechanical filtration, but these by-products fail to maintain a sufficient biological cleaning of the water. It is found that the compacted sand or granular filters typically become encapsulated in detritus, which results in a reduced water flow through the filter and as such a reduced biological cleaning of the water.

In accordance with the present invention as seen from a first aspect, there is provided a fluid cleaning medium, the medium comprising a plurality of discrete cleaning units, each unit comprising a body having a surface comprising a plurality of protuberances disposed thereon which are arranged to maintain a separation of the body surfaces of adjacent units of the medium to enable fluid to pass between the units.

Advantageously, the protuberances on the cleaning units serve to hold the units in spaced relation so that the fluid can pass through the medium and therefore interact with the surface area of the units. This increased surface area provides for a larger colonisation of nitrifying bacteria and therefore an improved biological filtration. It is also found that the protuberances act as paddles to rotate the units under a backwash for example, to agitate the medium to remove any debris held on the surface of the units.

Preferably, the protuberances are angularly separated around the body of the respective units and the protuberances associated with each unit are preferably separately arranged to extend in a common plane.

The body preferably comprises a substantially spherical shape and the protuberances preferably extend substantially radially away from the surface of the body.

The units preferably further comprise at least one passageway formed within the respective body. The at least one passageway preferably extends through the respective body and enables the fluid to flow through the respective units to thereby increase the effective surface area of the cleaning units for the colonisation of bacteria. One or more of the passageways associated with each unit preferably comprise a cross-sectional area which varies along the length of the respective one or more passageways.

Preferably, the at least one passageway associated with each unit extends in a direction which is substantially transverse the plane in which the protuberances extend.

The cleaning units are preferably formed of a rigid plastic material and are preferably buoyant in the fluid.

In accordance with the present invention as seen from a second aspect, there is provided a fluid cleaning device, the device comprising a flow path for conveying a fluid flow between a device inlet and a device outlet, the path comprising a cleaning chamber having an inlet for receiving fluid into the chamber and an outlet for passing fluid from the chamber, the chamber comprising a cleaning medium which is arranged to clean the fluid as it passes along the path between the chamber inlet and the chamber outlet,
the device further comprising dispersing means disposed within the path upstream of the cleaning chamber for dispersing the fluid flow across the cleaning medium to encourage the interaction of the water with the cleaning medium.

The dispersing means is preferably disposed within the inlet to the chamber and preferably comprises a mesh or an apertured plate which is arranged to extend across the inlet.

The cleaning medium is preferably housed within the chamber between a first mesh or apertured plate disposed upstream of the fluid flow and a second mesh or apertured plate disposed downstream of the fluid flow. The second plate is preferably disposed upstream of the chamber outlet and is arranged to minimise a directional flow of fluid from the medium to the outlet of the chamber. This reduced directionality of the fluid through the medium facilitates an interaction of the fluid with the medium throughout the chamber, rather that a central portion thereof, for example.

The first and second plates of the chamber are preferably held separated, in a fixed configuration, such that the cleaning medium is free to move between the plates.

Alternatively, the separation of the first and second plates of the chamber is preferably variable between a first configuration in which the cleaning medium is mobile and a second configuration in which the cleaning medium is substantially immobile. With this second separation, the cleaning medium preferably comprises a compacted configuration, which helps minimise any detritus removed from the fluid, from escaping the medium. The outlet of the chamber comprises a reduced cross-sectional area compared with a cross-sectional area of the chamber. This reduced cross-sectional area is arranged to draw the fluid from around the chamber, rather than directly toward the outlet, and is arranged to minimise the tracking of the fluid through a narrow column of the cleaning medium.

The device preferably comprises a first cleaning chamber and a second cleaning chamber disposed downstream of the first chamber, which separately comprise a cleaning medium disposed between a first and second mesh or apertured plate.

The first and second plate of the first chamber are preferably held separated in a fixed configuration, such that the cleaning medium is free to move between the plates, and the separation of the first and second plates of the second chamber is preferably variable, between a first configuration in which the cleaning medium is mobile and a second configuration in which the cleaning medium is substantially immobile.

The device preferably further comprises a sterilisation chamber disposed within the flow path. The sterilisation chamber comprises an inlet for receiving fluid from the path into the chamber and an outlet for passing fluid from the chamber. The chamber preferably comprises a lamp which is arranged to expose the fluid passing therethrough to sterilising radiation, such as ultra violet radiation.

Preferably, the device further comprises a conduit arrangement for conveying an air flow around the device. The arrangement preferably comprises a plurality of air jets for directing air into the cleaning medium to agitate the cleaning medium to dislodge any detritus held thereon.

The device preferably further comprises a drainage chamber arranged in fluid communication with the flow path via a drainage aperture, which is arranged to receive any detritus which settles from the fluid. Preferably, the drainage chamber comprises a partition for separating the chamber into a first and second drainage sub-chamber and which prevents fluid from passing from the first sub-chamber into the second sub-chamber.

The first sub-chamber is preferably arranged in fluid communication with the flow path upstream of the cleaning chamber and is arranged to receive any detritus which settles from the fluid through a first drainage aperture. The second sub-chamber is preferably arranged in fluid communication with the path downstream of the cleaning chamber or as appropriate, the first and second chambers, and is arranged to receive any detritus which settles from the fluid through a second drainage aperture.

Preferably, the first and second sub-chambers are arranged in fluid communication with a respective first and second drain port for draining any detritus from the respective first and second sub-chamber.

Preferably the cleaning medium associated with the water cleaning device of the second aspect, comprises the cleaning medium of the first aspect. Preferred features of the cleaning medium associated with the second aspect may comprise one or more of the preferred features of the cleaning medium of the first aspect.

An embodiment of the present invention will now be described by way of example only and with reference to the accompanying drawings, in which:

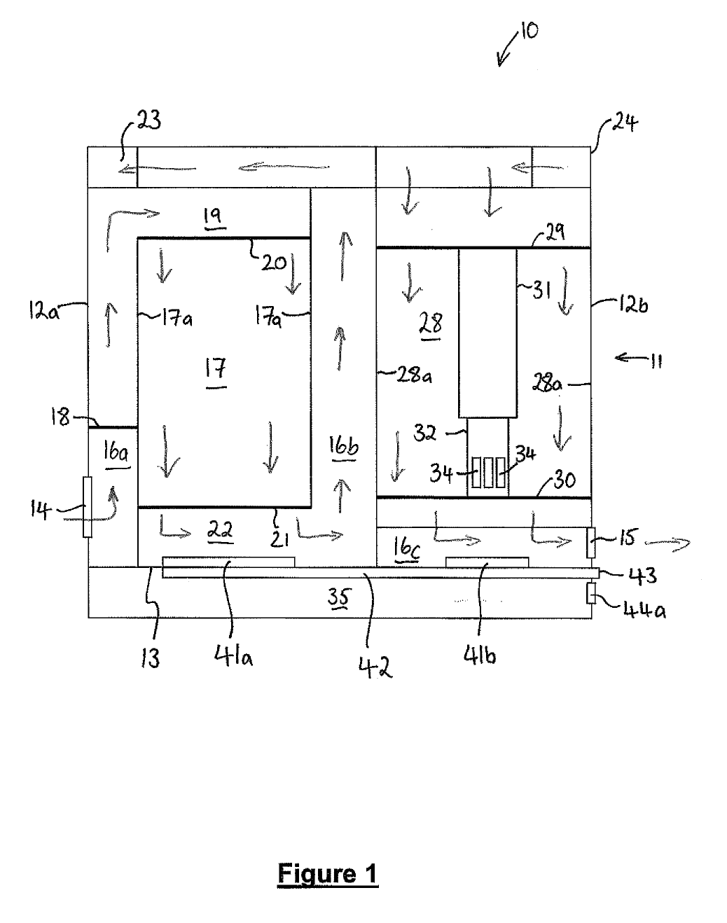

FIG. 1 is a side view of the cleaning device according to an embodiment of the present invention, from the front;

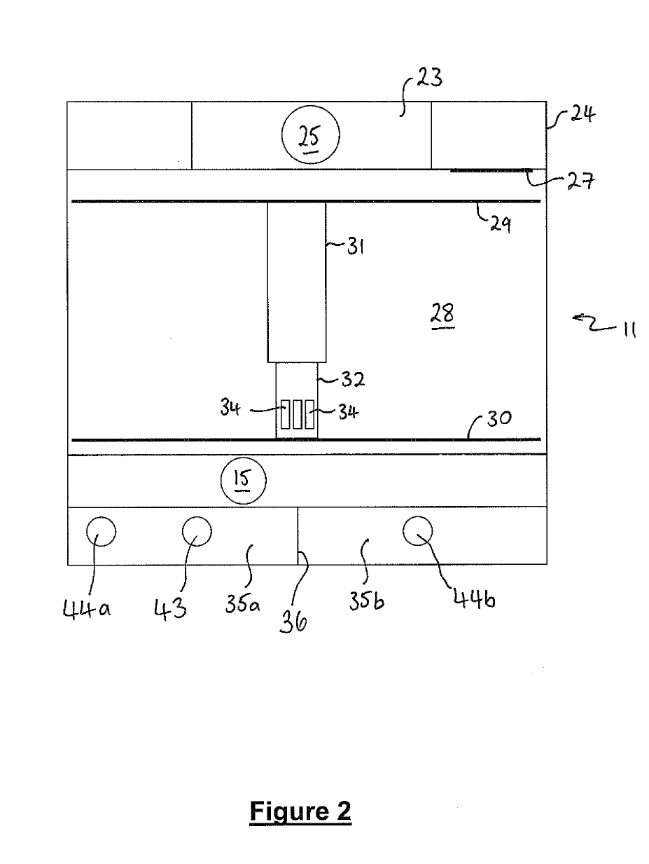

FIG. 2 is a front view of the cleaning device illustrated in FIG. 1;

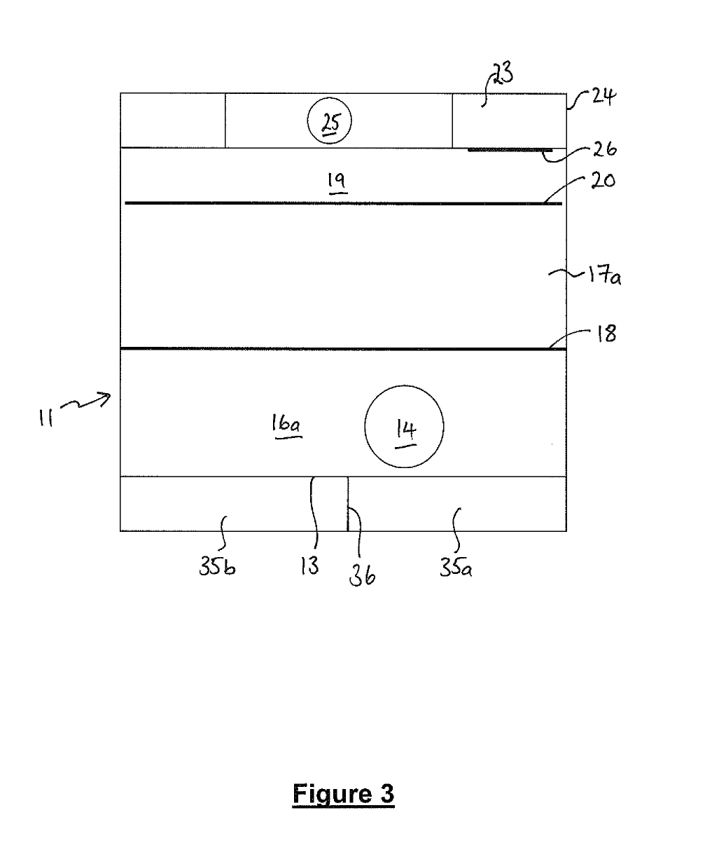

FIG. 3 is a rear view of the cleaning device illustrated in FIG. 1;

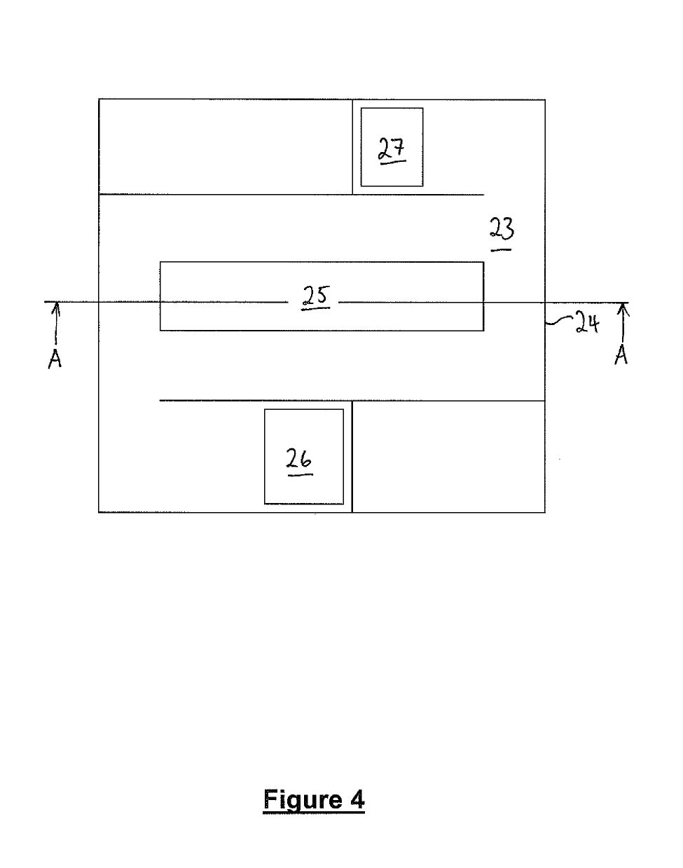

FIG. 4 is a plan view of the cleaning device illustrated in FIG. 1;

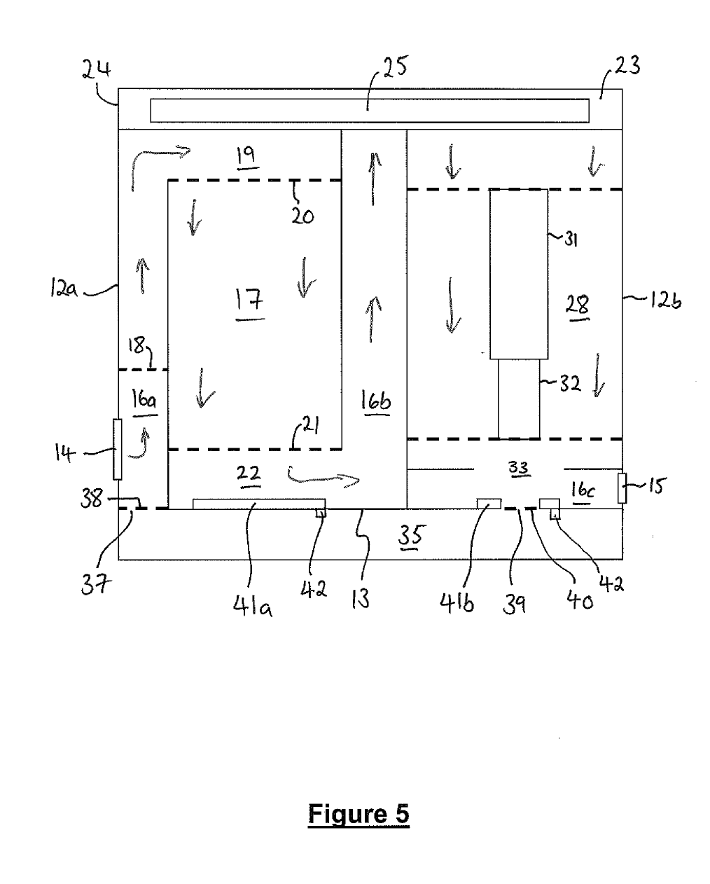

FIG. 5 is a sectional view across a line A-A of the cleaning device illustrated in figure

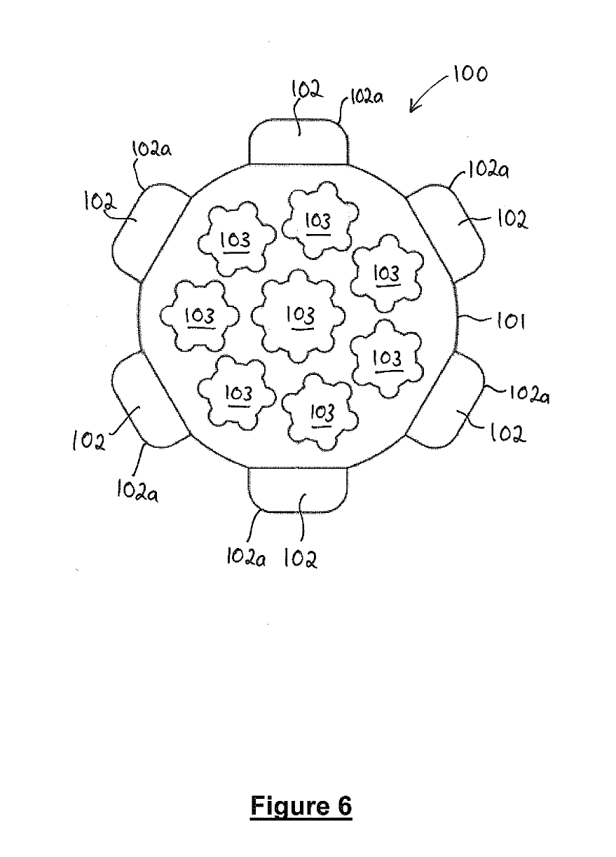

FIG. 6 is a perspective view of a cleaning unit of the cleaning medium according to an embodiment of the present invention, from a first viewpoint; and,

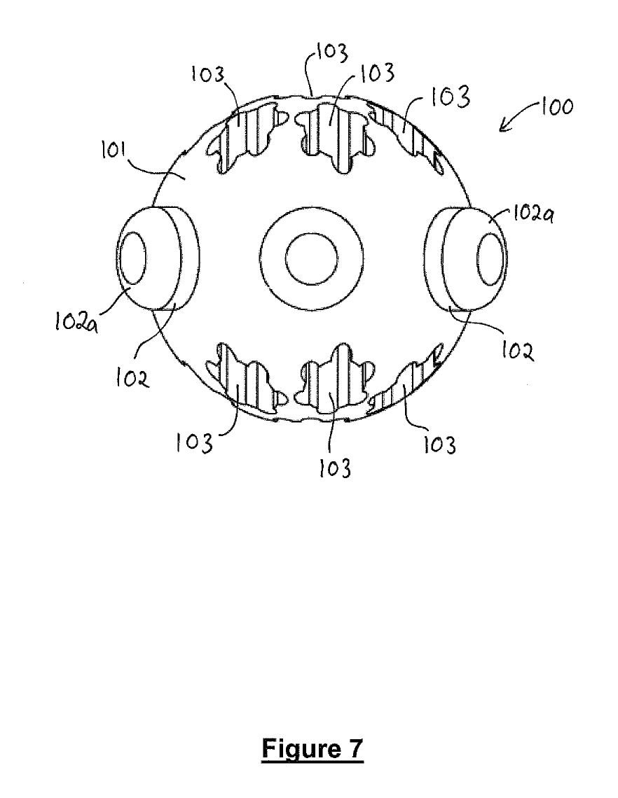

FIG. 7 is a perspective view of a cleaning unit illustrated in FIG. 6, from a second viewpoint.

Referring to FIGS. 1 of the drawings there is illustrated a side view of a fluid cleaning device 10 for cleaning pond water, bathing water and the like, according to an embodiment of the present invention. The device 10 comprises a substantially cuboid housing 11 comprising side walls 12 which extend from a base 13 thereof and which terminate at an upper open periphery. The device 10 further comprises an inlet 14 for receiving dirty water, such as dirty pond water, into the housing 11 and an outlet 15 for passing cleaned water out from the housing 11, for return to the pond (not shown) as illustrated in FIGS. 2 and 3 of the drawings. The inlet 14 is arranged to extend through a rear wall 12a of the device and is arranged to communicate the dirty water to a flow path or duct 16 which extends from the inlet 14 and which is arranged to communicate the water around the device 10 to the outlet 15. The flow duct 16 comprises an inlet portion 16a disposed proximate the inlet 14 which is arranged to communicate the water to a first cleaning chamber 17. The inlet duct 16a comprises a meshed or apertured dispersion plate 18 therein which extends across the duct 16a and which is arranged to disperse the water flow evenly across the inlet duct 16a so that the flow extends uniformly along the inlet duct 16a to the first cleaning chamber 17.

The first cleaning chamber 17 comprises an inlet 19 disposed above the first chamber 17, which is arranged to communicate the water from the inlet duct 16a into the chamber 17. The inlet 19 to the first cleaning chamber 17 comprises a further grill or meshed plate 20 which is further arranged to disperse the water flowing into the chamber 17, across the chamber to minimise directional flow developing through the chamber 17. The first chamber 17 comprises side walls 17a which extend between upper and lower regions of the housing 11 and which are orientated such that the chamber 17 comprises a substantially square cross-sectional shape. The first cleaning chamber 17 comprises a cleaning medium (not shown in FIGS. 1 to 5 of the drawings) disposed therein which is arranged to clean the water as it passes therethrough. The cleaning medium is housed between the side walls 17a of the chamber 17 and the upper grill or meshed plate 20 and a lower grill or meshed plate 21 which extends across an outlet 22 of the first chamber 17.

The upper and lower plates 20, 21 of the first cleaning chamber 17 are held in spaced relation and are held at a fixed separation so that the cleaning medium disposed therein can move freely with the water flow. On passing out through the first cleaning chamber 17, the water is arranged to pass upwardly of the housing 11, via a first connecting duct 16b to a sterilisation chamber 23, as illustrated in FIG. 4 of the drawings. The sterilisation chamber 23 is disposed within a cover or lid 24 of the device 10 which is arranged to sealingly locate upon the housing 11. The sterilisation chamber 23 comprises a lamp 25, such as an ultra violet lamp, which extends longitudinally of the cover 24 between an inlet 26 and an outlet 27 of the chamber 23 and is arranged to generate ultra violet radiation to sterilise the water passing therethrough.

Upon exiting the sterilisation chamber 23, the water is arranged to pass downwardly of the housing 11, through the outlet 27 of the chamber 23, into a second cleaning chamber 28. The second cleaning chamber 28 is substantially similar to the first cleaning chamber 17 and comprises side walls 28a which extend between upper and lower regions of the housing 11 and which are orientated such that the second chamber 28 comprises a substantially square cross-sectional shape. The second chamber 28 further comprises a cleaning medium (not shown in FIGS. 1 to 5 of the drawings) disposed between the side walls 28a of the chamber 28 and between an upper grill or meshed plate 29 and a lower grill or meshed plate 30, both of which extend across the width of the second chamber 28.

The first and second plates or grilles 29, 30 of the second cleaning chamber 28 are held in spaced relation by a first and second support tower 31, 32 which are respectively coupled to the first and second plate or grill 29, 30 substantially at the centre thereof, and are arranged in a substantially telescopic configuration. Accordingly, the first and second towers 31, 32 are arranged to move relative to each other to vary the spaced relation of the plates or grilles 29, 30 and thus the compacted form of the cleaning medium disposed therebetween.

The second cleaning chamber 28 comprises an outlet 33 is disposed downstream of the second grill or plate 30 and comprises a reduced cross-sectional area compared with the cross-sectional area of the second chamber 28. This reduced cross-sectional area causes the water to draw from around the cleaning medium, as opposed to through a narrow column of cleaning medium, and thus provides for an increased exposure of the cleaning medium to the water for an increased rate of colonisation and ultimately an increased colonisation area compared with existing water cleaners for a more effective nitrification of ammonia and nitrites within the water.

In order to minimise any blockages developing in the second cleaning chamber 28, the second tower 32 comprises a plurality of entry apertures 34 disposed proximate a base thereof, which is arranged to provide an alternative exit for the water from the second chamber 28. The alternative exit further serves to relieve the water pressure between the plates 29, 30 as the separation of the plates is reduced to compact the cleaning medium. The outlet 33 and apertures 34 are arranged in communication with an outlet duct 16c of the device which is arranged to communicate the cleaned water to the outlet 15 of the device 10, which is disposed in a front wall 12b of the housing 11.

The cleaning device 10 further comprises a drainage chamber 35 disposed at the underside of the housing base 13. The drainage chamber 35 comprises substantially the same cross-sectional area and shape as the housing 11 and comprises a partition 36 which is arranged to extend along the chamber 35 between a front and rear thereof to separate the drainage chamber 35 into a first and second drainage chamber 35a, 35b.

The first drainage chamber 35a is arranged in fluid communication with the inlet duct 16a via a first drainage aperture 37 disposed in the base 13 of the housing 11, proximate the inlet duct 16a. The first drainage aperture 37 comprise a mesh or aperture plate 38 for example, which extends across the aperture 37 and enables any detritus which settles in the inlet duct 16a to pass from the inlet duct 16a, and thus the housing 11, into the first drainage chamber 35a.

The second drainage chamber 35b is arranged in fluid communication with the outlet duct 16c via a second drainage aperture 39 disposed in the base of the housing 13 proximate the outlet 33 of the second cleaning chamber 28. The second drainage aperture 39 comprise similarly comprises a mesh or aperture plate 40 for example, which extends across the aperture 39 and enables any detritus which settles from the second cleaning chamber 28 to pass into the second drainage chamber 35b via the second aperture 39.

In use, dirty pond water for example may be gravity fed into the device 10 via the inlet 14 or may alternatively be circulated around the device 10 using a pump (not shown). As the dirty water passes through the first and second cleaning chambers 17, 28, the cleaning medium disposed therein is arranged to mechanically filter particulates and detritus from the water. In addition, the cleaning medium is arranged to provide a colonisation surface for the colonisation of nitrobacter and nitrosomonas which are arranged to convert harmful ammonia and nitrites into less harmful nitrates. The cleaning medium disposed in the first cleaning chamber 17 is arranged to move around under the water flow, whereas, the medium disposed in the second cleaning chamber 28 is held compacted and substantially immobile, owing to a reduced separation of the first and second grilles or plates 29, 30, to retain and detritus which becomes removed from the water.

Referring to FIGS. 6 and 7 of the drawings, the cleaning medium disposed in each chamber 17, 28 comprises a plurality of cleaning units 100 which separately comprise a substantially spherical body 101 formed of a plastic material. The plastic body 101 is substantially buoyant in water and as such, the cleaning units within the first and second chambers 17, 28 are arranged to float toward the respective upstream or first mesh or grill 20, 29.

The units 100 further separately comprise a plurality of protuberances 102 formed on the surface of the body 101 which extend radially from the body 101. The protuberances 102 are substantially cylindrical in cross-section and are closed at their distal end by a domed wall 102a. The protuberances 102 are arranged to extend in a common plane which also comprises the centre of the respective unit 100 and serve to maintain a separation of the body 101 of adjacent units 100 within the medium to enable the water to circulate between the units 100. The protuberances effectively serve as spacers to minimise any closed voids developing between the units 100. The improved circulation of water through the medium exposes the water and thus the nitrobacter and nitrosomonas to a larger colonisation area for a more effective conversion of ammonia and nitrites to nitrates.

To further increase the colonisation area, the units 100 separately further comprise a plurality of passageways 103 which extend through the body 101 thereof. In the embodiments illustrated in FIGS. 6 and 7 of the drawings, the passageways 103 extend through the body 101 in a direction substantially perpendicular to the plane of the protuberances 102. The passageways 103 comprise a substantially hexagonal cross-sectional shape, however, it is to be appreciated that other cross-sectional shapes may alternatively or additionally be used. The passageways 103 may further comprise a cross-sectional area which varies along the passageway 103 to further increase the surface area for the colonisation of nitrifying bacteria. In an alternative embodiment, which is not illustrated, the passageways 103 may further or alternatively comprise channels (not shown) formed within the surface of the body 101 and which extend around the surface of the body 101.

The cleaning medium within the first and second cleaning chambers 17, 28 is arranged to both mechanically and biologically clean the water passing therethrough. The diameter of the units in the first chamber 17 however is arranged to be larger than that of the units 100 in the second chamber 28 to remove larger particulates prior to the water passing to the second cleaning chamber 28.

The device 10 further comprises a conduit arrangement 41a, 41b disposed at the downstream side of the first and second cleaning chambers 17, 28, respectively. Each arrangement 17, 28 is substantially annular in shape and is communicatively coupled to an air supply (not shown) via a connecting conduit 42 which couples the first and second arrangement 41a, 41b to a valve 43 disposed on the front wall 12b of the housing 11. The conduit arrangement 41a, 41b disposed downstream of the first and second cleaning chambers 17, 28 comprise a plurality of jet outlets (not shown) for directing jets of air into the respective chamber to agitate the cleaning medium. The medium disposed in the first chamber 17 is free to move around the chamber 17 owing to the relatively large separation of the first and second grill or mesh plate 20, 21 in the first chamber 17, however the medium in the second chamber 28 is compacted due to the relatively small separation of the first and second grills or meshed plates 20, 21 disposed therein.

Accordingly, in order to clean the medium, the water flow through the device 10 is first stopped by closing the inlet 14 and the outlet 15 of the device 10 and the first and second grills or meshed plates 29, 30 in the second cleaning chamber 28 are separated by moving the support towers 31, 32 relative to each other to increase the separation of the plates 29, 30, so that the cleaning medium disposed thereon can move around within the second chamber 28. Air is then communicated from the valve inlet 42 to the conduit arrangements 41a, 41b so that jets of air become directed into the cleaning medium of each chamber 17, 28 to agitate the units 100 to cause any detritus and/or particulates disposed thereon to become dislodged. The substantially spherical shape of the body 101 of each unit 100 is found to cause the units 100 to rotate under the air flow, and the protuberances 102 associated with each unit 100 are found to capture the air flow and thus assist the rotation of the units 100.

The dislodged particulates and/or detritus within the device 10 is then removed by withdrawing the water from the device 10 through a first and second drainage port 44a, 44b disposed in the front wall 12b of the housing 11. During this process, water is drawn into the device 10 through the outlet 15 to cause water to flow in the opposite direction through the device 10. The first drainage port 44a is arranged in fluid communication with the first drainage chamber 35a and the second drainage port 44b is arranged in fluid communication with the second drainage chamber 35b. In this respect, the first drainage port 44a is arranged to remove any detritus or particulates which pass into the first drainage chamber 35a from the inlet duct 16a during the backwash, whereas, the second drainage port 44b is arranged to remove any detritus or particulates which pass into the second drainage chamber 35b from the first and second cleaning chambers 17, 28.

Once all the detritus has been removed, the drainage ports 44a, 44b are closed and the air supply to the conduit arrangements 41a, 41b is switched off. The separation of the first and second plates or grills 29, 30 in the second cleaning chamber 28 is then reduced to compact the cleaning medium, and the inlet 14 may then be opened so that water can pass into the device 10 for subsequent cleaning.

In an alternative embodiment (not shown) the second cleaning chamber comprises a removable container member having an apertured base in place of the grille 30 and upstanding side walls extending parallel to the walls 28a. The container member comprises an open top in which the apertured plate 29 is slidably received. A removable apertured cover plate extends across the top of the compartment in which the container member is seated. An elongate shaft extends upwardly from the apertured plate 29 through the cover plate, a handle being provided at the upper end of the shaft for moving the apertured plate 29 up and down during cleaning.

From the foregoing therefore, it is evident that the cleaning device and medium provide an improved cleaning of water.

1. A fluid cleaning medium, the medium comprising a plurality of discrete cleaning units, each unit comprising a body having a surface comprising a plurality of protuberances disposed thereon which are arranged to maintain a separation of the body surfaces of adjacent units of the medium to enable fluid to pass between the units.

2. The medium according to claim 1, wherein the protuberances are angularly separated around the body of the respective units.

3. The medium according to claim 1, wherein the protuberances associated with each unit are separately arranged to extend in a common plane.

4. The medium according to claim 1, wherein the body comprises a substantially spherical shape and the protuberances extend substantially radially away from the surface of the body.

5. The medium according to claim 1, wherein the units further comprise at least one passageway which extends through the respective body.

6. The medium according to claim 5, wherein the at least one passageway enables the fluid to flow therethrough to increase the surface area of the cleaning units for the colonisation of bacteria.

7. The medium according to claim 5, wherein the or at least one passageway associated with each unit comprise a cross-sectional area which varies along the length of the passageway.

8. The medium according to claim 5, wherein the at least one passageway extends in a direction which is substantially transverse the plane in which the protuberances extend.

9. (canceled)

10. (canceled)

11. The fluid cleaning device, the device comprising a flow path for conveying a fluid flow between a device inlet and a device outlet, the path comprising a cleaning chamber having an inlet for receiving fluid into the chamber and an outlet for passing fluid from the chamber, the chamber comprising a cleaning medium which is arranged to clean the fluid as it passes along the path between the chamber inlet and the chamber outlet, the device further comprising dispersing means disposed within the path upstream of the cleaning chamber for dispersing the fluid flow across the cleaning medium to encourage the interaction of the water with the cleaning medium.

12. The device according to claim 11, wherein the dispersing means is disposed within the inlet to the chamber and comprises a mesh or an apertured plate which is arranged to extend across the inlet.

13. The device according to claim 11, wherein the cleaning medium is housed within the chamber between the first mesh or apertured plate disposed upstream of the fluid flow and a second mesh or apertured plate disposed downstream of the fluid flow.

14. The device according to claim 13, wherein the second plate is disposed upstream of the chamber outlet and is arranged to minimise a directional flow of fluid from the medium to the outlet of the chamber.

15. The device according to claim 13, wherein the first and second plates of the chamber are held separated, in a fixed configuration, such that the cleaning medium is free to move between the plates.

16. The device according to claim 13, wherein the separation of the first and second plates of the chamber is variable, between a first configuration in which the cleaning medium is mobile and a second configuration in which the cleaning medium is substantially immobile.

17. The device according to claim 14, wherein the cleaning medium comprises a compacted configuration in the second plate configuration, which helps minimise any detritus removed from the fluid, from escaping the medium.

18. The device according to claim 11, comprising a first and second cleaning chamber disposed within the flow path, the second cleaning chamber being arranged downstream of the first cleaning chamber.

19. The device according to claim 18, wherein the first and second cleaning chambers separately comprise a cleaning medium and a first and second mesh or apertured plate, the cleaning medium being disposed within the chambers between the respective first and second plates.

20. The device according to claim 19, wherein the first and second plate of the first chamber are held separated in a fix configuration, such that the cleaning medium is free to move between the plates, and the separation of the first and second plates of the second chamber is variable between a first configuration in which the cleaning medium is mobile and a second configuration in which the cleaning medium is substantially immobile.

21. (canceled)

22. (canceled)

23. (canceled)

24. (canceled)

25. (canceled)

26. (canceled)

27. (canceled)

28. (canceled)

29. (canceled)

30. The device according to claim 11, wherein the cleaning medium comprises a fluid cleaning medium.
